(19) United States
(12) Patent Application Publication
(10) Pub. No.: US 2010/0047411 A1
(43) Pub. Date: Feb. 25, 2010

(54) BREADING MACHINE AND METHODS OF OPERATION

(75) Inventors: Donald A. Mather, Sandusky, OH (US); Jason Jeong, Duluth, GA (US); John Crapps, Hoschton, GA (US); Scott D. Mather, Huron, OH (US)

Correspondence Address: HAHN LOESER & PARKS, LLP, One GOJO Plaza, Suite 300, AKRON, OH, 44311-1076, US

(73) Assignee: ALKAR-RAPIDPAK-MP EQUIPMENT, INC., Lodi, WI (US)

(21) Appl. No.: 12/612,919

(22) Filed: Nov. 5, 2009

Related U.S. Application Data
(62) Division of application No. 11/039,380, filed on Jan. 19, 2005.

(51) Int. Cl. A23P 1/08; A23L 1/48

(52) U.S. Cl. 426/289

(57) ABSTRACT

A breading machine, and improvements thereto, for use in high volume food production is disclosed. In accordance with an embodiment of the present invention, an improved breading machine includes a side-mounted feed hopper, a low pressure auger assembly including an auger transfer box with an input port for accepting a cross-feed screw and paddle, and an output port for transferring coating material to a vertical screw. The improved breading machine also includes a substantially cylindrical, rod-based spreader assembly and a transport conveyor belt for feeding the spreader assembly within a top hopper of the breading machine. The improved breading machine further includes a vibrating filter assembly to filter out clumps of coating material while allowing un-clumped material to be re-used within the breading machine.

### CROSS-REFERENCE TO RELATED APPLICATIONS/INCORPORATION BY REFERENCE

This application is a divisional patent application of U.S. non-provisional patent application Ser. No. 11/039,380, filed Jan. 19, 2005, which is incorporated herein by reference in its entirety.

### TECHNICAL FIELD

The present invention relates to food processing equipment and methods, for the coating or breading of food products. More particularly, certain embodiments of the present invention relate to a coating machine and methods for dispensing a coating material (e.g., flour, bread crumbs, cracker meal) onto food products, such as in large-scale food processing lines.

### BACKGROUND OF THE INVENTION

In the industry of high volume production of food products, it is desirable to coat certain food products (e.g., chicken) with, for example, batter and a breading material before cooking the food products. Breading material may include a relatively dry material such as fine particle flour breading, Japanese-style breadcrumbs having a large distribution of bread crumb sizes, cracker meal of differing particle sizes, or many other types of coating materials. Each type of breading or coating material has its own characteristics that cause the breading material to react in differing ways when being distributed within a breading or coating machine and onto food products.

For example, a flour type breading made of wheat or some other grain may have a tendency to pack or clog causing the material to bridge over transition spots within the breading machine. Such bridging acts to hamper the free-flow of the breading material through the machine.

Japanese style crumbs typically comprise modified wheat flour along with some salt, sugar, yeast, oil, and possibly other ingredients as well. The Japanese style crumbs can vary in size from that of a small flour particle to a half an inch in diameter. Japanese style crumbs tend to get clogged over larger openings than other common grain breading flours.

Automated breading machines for applying breading and various types of coatings, including flour, to food products for mass production have been manufactured since the late 1940's. The original machines were for coating products such as fish sticks, fish portions, shrimp, and some poultry products. With a major growth in coated or breaded foods including onion rings, fish sticks, nuggets, shrimp, meat patties, and a full variety of chicken nuggets, tenders, wings, etc., breading machine design has changed to accommodate the wide variety of food products. Coated food products are used in mass quantities in retail grocery stores, food service (e.g., schools), and quick service restaurants.

Coating material originally was primarily dried bread crumbs, being granular in nature, and what is considered to be a free flowing type of material. Over the years the coatings have turned more to spiced flour, which has required manufacturers of coating machines to redesign the machines to handle these flour type coatings, which are not considered to be free flowing. For example, if one picks up a hand full of flour and squeezes it, the flour compacts and balls up. On the other hand, a granular type of coating material does not compact when squeezed but, instead, will sift through your fingers, similar to granular salt or sugar.

Today, there is a new variety of spiced flour coating that is applied in a heavy texture called home style. It is generally formed as a build up of wet batter and flour that is applied in multiple stages. Along with new coatings, process line capacity has grown from the two or three thousand pounds per hour to eight to ten thousand pounds per hour and more. Process line durability and coating material control is more critical today than ever. Additionally, food safety standards require sanitary designs, and the machines must be safe to operate.

Certain difficulties with respect to traditional breading machines also include loading the breading machine with the breading material, applying the breading material evenly over the food products, preventing clogging or bridging of the breading material within the breading machine, and eliminating clumping of the breading material within the breading machine.

For example, many breading machines use a breading recirculation system where breading is distributed onto a conveyor to form a bottom coating layer, and to the tops of food products as they travel through the machine on the conveyor. Such machines have in turn used a top hopper for loading breading or coating materials into the machine, and for distribution of coating onto the tops of food products. When the top hopper gets low on coating material, an operator adds one to three bags of new coating material to the top hopper. As a result, the tops of the food products going through the breading machine are coated with all new material resulting in different coating granulation between the top and bottom of the food products. It would be desirable to provide a uniform breading material to both sides of food products. Further, in one known machine, the top coating is sprinkled on using a cross conveyor that creates a sprinkle effect and attempts to break up clumps of coating material into a fine powder. However, such an arrangement causes significant dust, which is not desirable in the processing plant environment. The arrangement also causes the top coating material to be applied at an angle and more coating is dispensed at the beginning portion of the cross conveyor, creating non-uniform coating across the width of the food product conveyor. Additionally, the useful life of the conveyor belt within the top hopper is shortened by the fact that, in many cases, the top hopper is used as the main supply reserve and the heavy load put on the belt causes the belt to stretch and break.

It is also desirable to remove clumps of batter and breading that may be generated, or larger crumbs or food particles from the machine to facilitate operation. A known machine attempts to remove such materials from the top hopper area. Such a system requires such materials to be recirculated throughout the machine before they can be removed. It would be worthwhile to allow such materials to be removed before they are recirculated. Additionally, recirculation systems have been designed using an auger system. It has been found that transferring coating material from auger to auger tends to be a problem and increases in difficulty as moisture builds up in the coating material. High volumes and/or the type of breading material can therefore cause jams at the augers, requiring the machine to be stopped for cleaning of such jams, resulting in process down time. Also with respect to recirculation of breading materials, only about 30% of the coating material is received back at the top hopper and, therefore, only this 30% gets screened. Some industry machines use two augers, three augers, or up to four augers. Some machines use electric drives with chains and sprockets. Others use hydraulics with direct drives and still others use a 90-degree gearbox drive with chain or timing belts. There are various types of augers that are used. Some augers use uniform auger flights and others use increased flightings at transfer points.

Other problems with known breading machines relate to the need for a belt tensioning system for the food product conveyor, to the belt to be set correctly depending on the loading and speed of the belt. Some breading machines have a belt tension system that moves a conveyor support shaft forward, so as to tighten the tension on the main breading belt. However, this results in the breading machine effectively becoming longer, increasing the footprint on the plant floor, and making it more likely that the main belt may get tangled with other processing machinery in the processing line. It would therefore be desirable to provide a tensioning system that would not result in lengthening.

For safety, known breading machines typically have covers over the augers, but if a cover is opened, the auger is exposed, making accidents possible. Newer machines may have safety cut outs or electronic devices that shut down the machine if a cover is opened, but such safety switches have proven not to be reliable and, in some cases, are rendered inoperative, which creates an even greater safety issue. Although an auger guard may be used inside the cover, this presents problems when cleaning of the machine is necessary. It would be desirable to provide easy cleaning without presenting a safety hazard (i.e., direct access to the auger).

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

An embodiment of the present invention comprises a breading machine for dispensing a coating material onto food products. The breading machine includes an enclosure defining a breading chamber, and a conveyor to move the food products through the breading chamber. The breading machine may also include a side-mounted feed hopper for simplified loading the coating material into the breading chamber and onto a lower return path of the conveyor means. Also included is a top-mounted hopper for receiving the coating material internally within the breading machine and for dispensing the coating material onto at least a top surface of the food products.

The coating machine in one embodiment includes an auger transfer box having an input port and an output port. A cross-feed screw having a first end and a second end is used to distribute breading material to the auger transfer box. The auger transfer box is shaped to have a configuration that promotes the movement of breading or coating materials therethrough, and more particularly, may have flow enhancing angled or curved connecting surfaces between sidewalls of the transfer box, instead of orthogonally related walls. The cross-feed screw may have at its second end has a paddle mounted thereon and positioned within the auger transfer box. The cross-feed screw is adapted to accept the coating material within the breading machine and move the coating material toward the second end of the cross-feed screw and into the auger transfer box via the input port as the cross-feed screw rotates. The coating machine also includes at least one feed screw having a first end and a second end, which is adapted to accept the coating material from the output port of the auger transfer box at the first end of the screw as the paddle rotates within the auger transfer box.

Another embodiment of the present invention comprises an auger assembly for use in a breading machine. The auger assembly comprises an auger transfer box having an input port and an output port. The auger assembly further comprises a cross-feed screw having a first end and a second end and being adapted to accept a coating material within the breading machine. The cross-feed screw moves the coating material toward the second end of the cross-feed screw and into the auger transfer box via the input port as the cross-feed screw rotates. The auger assembly also includes a paddle attached to the second end of the cross-feed screw. The paddle is positioned within the auger transfer box via the input port and pushes the coating material out of the output port of the auger transfer box as the cross-feed screw rotates. The coating machine also includes at least one feed screw having a first end and a second end, which is adapted to accept the coating material from the output port of the auger transfer box at the first end of the screw as the paddle rotates within the auger transfer box. The feed screw moves the coating material away from the auger transfer box toward the second end of the feed screw as the screw rotates. In a preferred form, two feed screws are provided, including an upper feed screw that feeds coating material to an upper distribution hopper, and a lower feed screw to feed and apply coating material to form a bottom layer of material on the conveyor prior to distribution of food products thereon.

A further embodiment of the present invention comprises a spreader assembly for distributing a coating material to at least a top of a food product in a relatively uniform or even manner in a breading or coating machine. The spreader assembly includes at least two mounting pieces and a plurality of rods mounted horizontally between the at least two mounting pieces. The spreader assembly further includes a motor and a drive shaft connecting the motor and at least one of the two mounting pieces. The spreader assembly is adapted to receive breading or coating material from a supply hopper, adjacent an outlet opening positioned above the conveyor of the machine on which food products are positioned. The plurality of rods act to uniformly distribute the material as it moves through the outlet opening, such that the material is sprinkled onto the tops of the food products located on the conveyor uniformly across the width of the conveyor.

In another aspect of the invention, the coating machine has a crumb filter assembly for removal of undesirable materials from the breading or coating process. The crumb filter is positioned adjacent the end of the main product conveyor system, such that excess breading or coating materials are dispensed thereon, prior to recirculation of breading material within the machine. The crumb filter is comprised of a conveyor system having a surface to allow uncontaminated breading or coating materials to pass therethrough, while any larger clumps of material are removed from the machine by the conveyor. The crumb filter may comprise a vibrating filter assembly having a conveyor belt positioned near a food product discharge end of the breading machine and oriented substantially perpendicular to and between an upper forward food product path and a lower return path of a main food product conveyor belt of the breading machine. The main food product conveyor belt pushes the coating material onto the filter conveyor belt. Smaller particles of the coating material fall through the filter conveyor belt and onto the lower return path of the main food product conveyor belt for reuse within the breading machine as the filter conveyor belt vibrates. Larger clumps of the coating material are carried out of the breading machine by the filter conveyor belt.

A further embodiment of the present invention includes a method to stabilize a coating material within a breading machine. The method comprises selectively metering in new coating material onto a lower return path of a main conveyor belt of the breading machine from a side-mounted supply hopper. The lower return path also carries a filtered coating material already processed at least once through the breading machine. The method further comprises transitioning the new coating material and the filtered coating material from the main conveyor belt through a low pressure auger assembly of the breading machine and then transitioning at least a first part of the coating materials from the low pressure auger assembly to a top distribution hopper of the breading machine. The method also includes transitioning the at least first part of the coating materials from the top distribution hopper and onto an upper path of the main conveyor belt using a rotating, rod-based spreader assembly positioned at an output end of the top hopper. The upper path carries food products through the breading machine. The method also includes filtering excess coating materials on the upper path of the main conveyor belt near a food product discharge end of the breading machine using a vibrating filter assembly. The method further comprises returning the filtered coating materials to the low pressure auger assembly via the lower return path of the main conveyor belt along with the new coating material being selectively metered in from the side-mounted feed hopper.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIGS. 1A-1D illustrate several views of a first embodiment of a breading machine, in accordance with various aspects of the present invention.

FIGS. 2A-2B illustrates two views of an alternative embodiment of a breading machine.

FIGS. 3A-3E illustrates several views of an embodiment of a side-mounted feed hopper used in the embodiments of FIGS. 1 and FIG. 2.

FIG. 4 illustrates an embodiment of an auger transfer box used in the breading machines of FIG. 1 and FIG. 2.

FIGS. 5A-5B illustrates several views of an embodiment of a cross-feed screw and paddle used in the breading machines of FIG. 1 and FIG. 2.

FIG. 6A illustrates an embodiment of a spreader assembly used in the breading machines of FIG. 1 and FIG. 2.

FIG. 6B illustrates the spreader assembly of FIG. 6A in operation in the breading machine of FIG. 1, in accordance with an embodiment of the present invention.

FIG. 7 illustrates a view of an embodiment of a filter assembly used in the breading machines of FIG. 1 and FIG. 2.

FIG. 8 illustrates a perspective view of an embodiment of a vibrator element used in the vibrating filter assembly of FIG. 7.

FIGS. 9A-9C illustrate several views of a transition region of an embodiment of a low pressure auger assembly in the breading machine according to the invention.

FIGS. 10A and 10B illustrate views of an embodiment of an in-line belt tensioning assembly of the breading machine in accordance with the present invention.

FIG. 11A illustrates an embodiment of a hinged auger guard used in the breading machine of FIG. 1.

FIG. 11B is an enlarged partial view of area B as noted in FIG. 11A.

FIG. 12 illustrates an embodiment of a method to stabilize a coating material within the breading machine according to the invention.

### DETAILED DESCRIPTION OF THE INVENTION

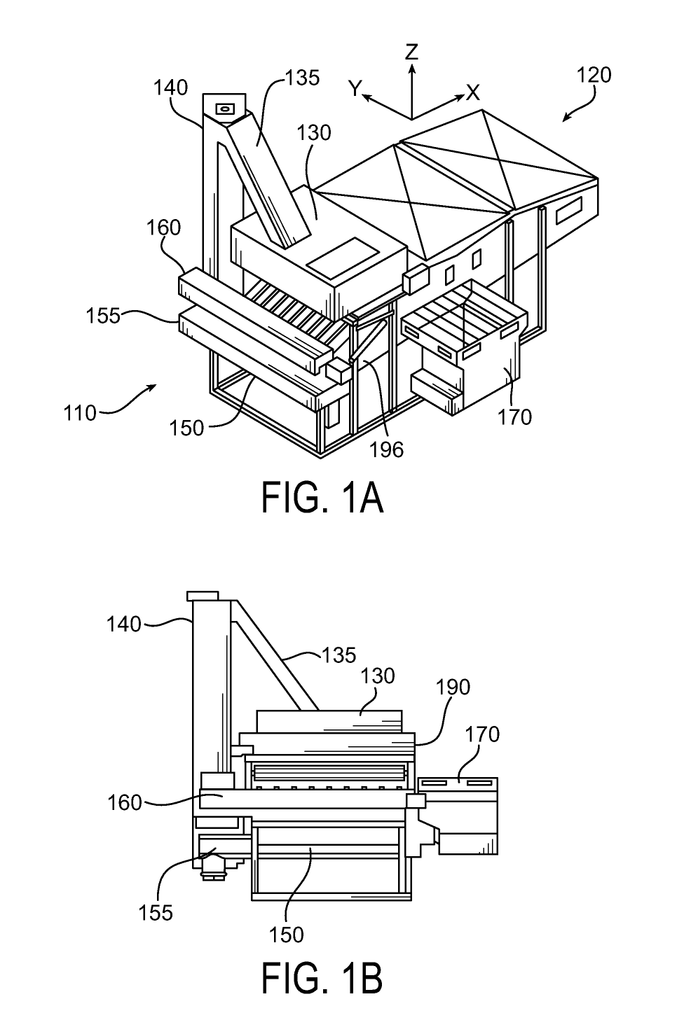

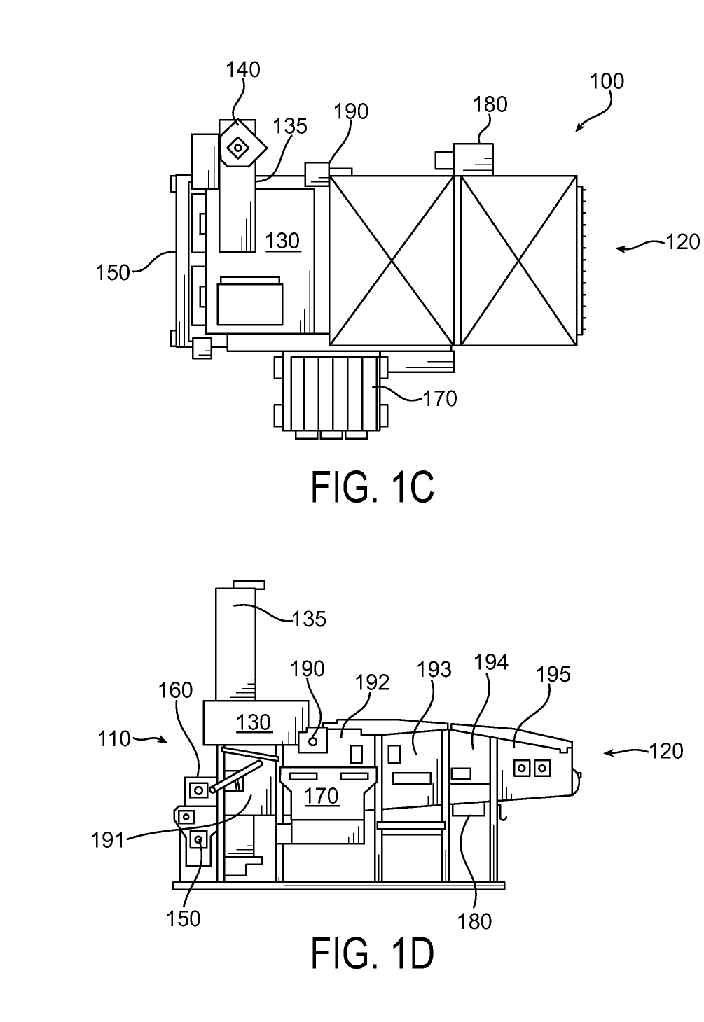

FIG. 1 illustrates several views of a first embodiment of a breading or coating machine 100. The breading machine 100 includes an input side 110 and an output side 120. Food products to be coated with a coating material (e.g., flour, bread crumbs, cracker meal) enter the breading machine 100 on the input side 110 and exit on the output side 120. The food products are typically fed into the input side 110 via a conveyor belt, for example, such as from prior equipment, such as a batter applicator. The food products are coated in the machine 100 and are typically fed out of the output side 120 and into, for example, a baking oven or fryer (not shown). The volumes of food products processed in this way are significant, and may be on the order of 10,000 pounds per hour or more, requiring significant amounts of coating materials, and distribution onto all of the food products passing therethrough in a uniform and desired manner. The breading characteristics desired for various food products, including the type of breading, thickness and other characteristics, must be achieved by a single machine for efficiency, and the ability to effectively control such parameters provides the user with a great amount of flexibility. The ability to control the function of the machine in these ways also allows the user to fashion the most cost effective coating process, while not sacrificing desired final product characteristics, such as by effective control of breading thickness. The machine 100 further provides low pressure handling of the breading materials within the machine to improve breading characteristics on the coated products.

The breading machine includes several sections including a top hopper 130, a top hopper feed chute 135, a vertical breading transport section 140, a first horizontal breading transport section 150, and a second horizontal breading transport section 160. The breading machine 100 also includes a coating transfer box 155, a side-feed hopper 170, a crumb filter assembly 180, and a top coating spreader assembly 190. The transport sections 140, 150, and 160 include screws or augers to transport the coating material through various parts of the breading machine 100.

The a machine 100 has a main endless food product/breading conveyor belt 196 running through several sections 191-195 of the breading machine 100. These sections 191-195 form a breading chamber enclosure. The conveyor belt 196 carries food products and coating material through the breading chamber enclosure via an upper forward path of the belt 196. Unused coating material is fed back and recirculated through the breading machine via a lower return path of the belt 196. The food products enter the breading machine 100 at the input side 110 without being coated, and exit via the output side 120 after having been coated by the breading machine.

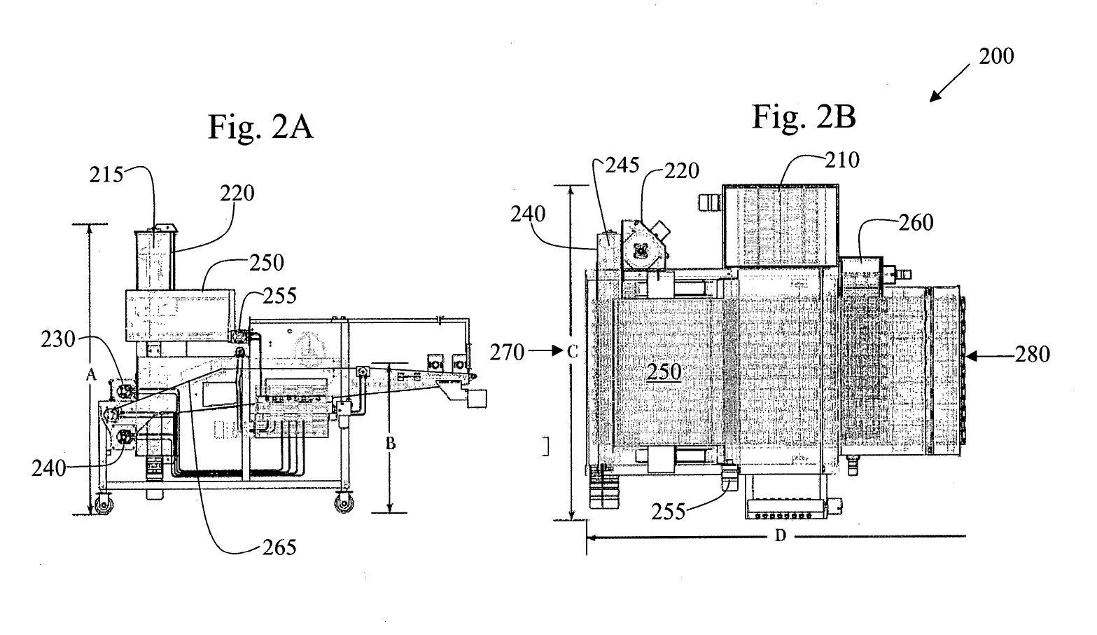

FIG. 2 illustrates two views of a second embodiment of a breading machine 200. The design of this second embodiment is very similar to the design of FIG. 1. However, in this second embodiment, a side-mounted feed hopper 210 is mounted on the opposite side of the breading machine 200 as compared to FIG. 1. This mounting provides flexibility in positioning the machine in a processing line adjacent other equipment. A vertical screw 215 can be seen within the vertical breading transport section 220. The breading machine 200 includes a first horizontal breading transport section 240, and a second horizontal breading transport section 230. A horizontal cross-feed screw 245 can be seen within the horizontal breading transport section 240.

The breading machine 200 also includes a top hopper 250, a spreader assembly 255, a filter assembly 260, and a main breading conveyor belt 265. The breading machine 200 has an input end 270 and an output end 280 for food products to enter and exit.

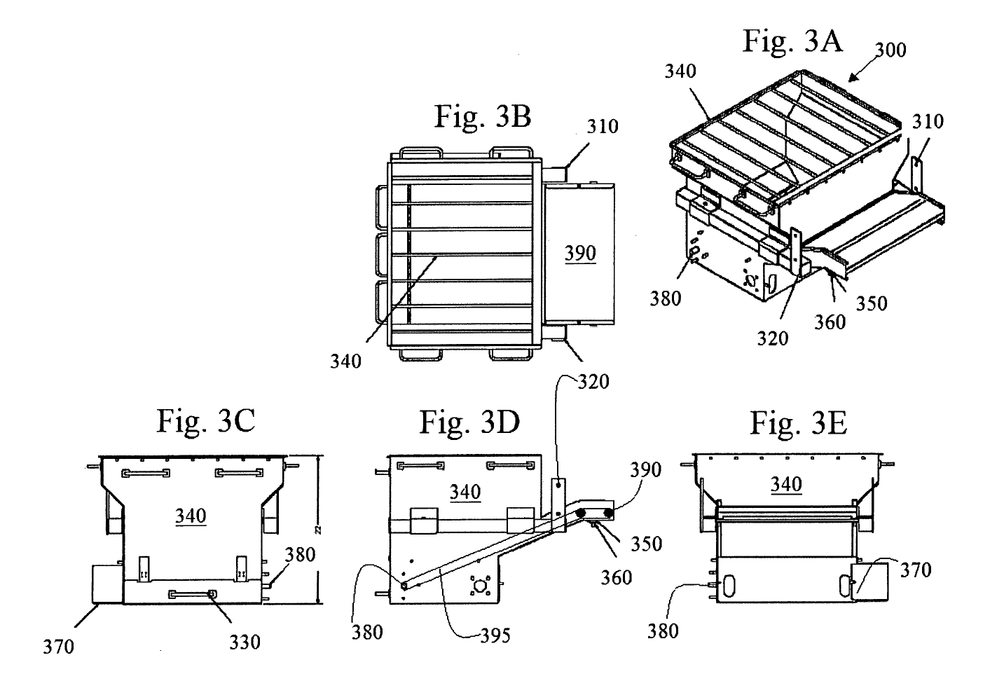

FIG. 3 illustrates several views of an embodiment of a side-mounted feed hopper 300 used in the breading machines of FIG. 1 and FIG. 2. The side-mounted feed hopper 300 includes a left mount arm 310, a right mount arm 320, a catch pan 330, a body assembly 340, a scraper 350, a scraper support 360, a motor assembly 370, and a drive shaft 380. The hopper 300 also includes an output chute 390 and an internal transport conveyor belt 395. The body assembly 340 and the catch pan 330 form a container to hold the coating material (e.g., bread crumbs or flour).

Coating material (e.g., flour) is fed into the breading machine (e.g., 100) via the side-mounted hopper 300. The side-mounted hopper 300 is mounted at a relatively low position on the side of the breading machine (see FIG. 1 and FIG. 2) and has an open top. Coating material may be easily loaded into the side-mounted hopper 300 by pouring the coating material into the open top of the side-mounted hopper. The open top of the side-mounted hopper is desirably no more than 1 meter above a floor surface to which the breading machine is mounted. A typical person loading the breading machine and standing on the floor surface next to the hopper 300 is able to easily pour an amount of the coating material into the open top of the hopper 300. This facilitates loading of smaller amounts of coating materials into the machine at a single time, thereby helping to maintain a uniform charging of breading and uniform distribution thereof.

The transport conveyor belt 395, driven by the motor 370 that is attached to the drive shaft 380, moves the loaded coating material from the container (330 and 340) through the output chute 390 and onto a lower return path of the main breading conveyor belt (e.g., conveyor belt 196 of FIG. 1 or 265 of FIG. 2). The transport conveyor belt 395 is oriented substantially at 90 degrees with respect to the main breading conveyor belt, in accordance with an embodiment of the present invention. The coating material is transported by the lower return path of the main breading conveyor belt toward the input end of the breading machine. In this way, new coating material charged to the system is introduced along with recirculated coating material, where it is uniformly blended with the recirculated coating before use in forming the bottom or tip coating layers on the food products.

Coating material falls from the lower return path down into the cross-feed screw (e.g., 245) where the coating material is transported to the vertical screw (e.g., 215) via the auger transfer box (e.g., 155). Some of the coating material being transported by the vertical screw is intercepted by a spreader screw (e.g., within the second horizontal breading transport section 160 or 230) which deposits coating material onto an upper forward path of the main conveyor belt before food products are introduced onto the belt. This provides a bottom coating for the food products to be moved onto. The vertical screw is operated (i.e., rotated) by a motor at the second end of the vertical screw as an example.

A portion of the coating material being transported by the vertical screw is fed into a top hopper (e.g., 130 or 250) via a top hopper feed chute (e.g., 135) interfacing between a second end of the vertical screw and the top hopper. A spreader assembly (e.g., 190 or 255) at an output end of the top hopper distributes the coating material downward onto the food products, fully coating the remaining portions of the food products not coated by the bottom coating layer on the belt. The coated food products then move toward an output end of the breading machine where excess coating material that does not adhere to the food products is filtered and returned, via a lower return path of the main breading conveyor belt, to be used again in forming the bottom and top coating streams within the breading machine. As should be recognized, an amount of coating is used continuously during the process as the food products move therethrough, and make up coating material is provided via the side-mounted hopper as described. The coated food products exit out the output end (e.g., 120 or 280) of the breading machine.

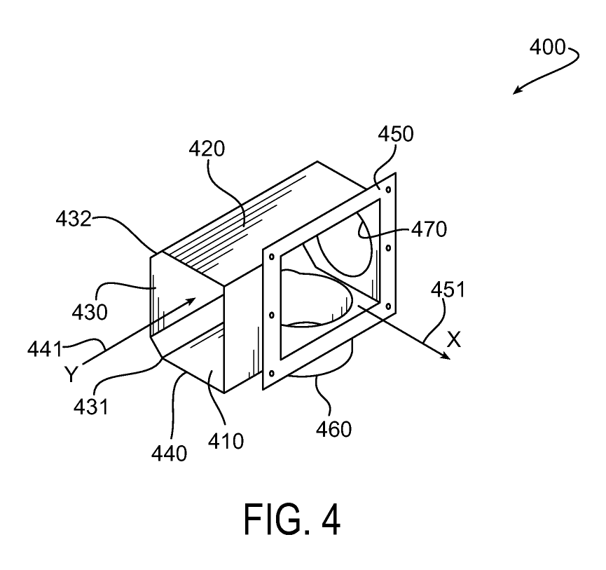

FIG. 4 illustrates two views of an embodiment of an auger transfer box 400 used in the breading machines of FIG. 1 (e.g., auger transfer box 155) and FIG. 2. The auger transfer box 400 includes a bottom side 410, a top side 420, and an angled side 430. The angled side 430 is connected between the bottom side 410 and the top side 420 such that the angled side 430 forms a first interior angle 431 with the bottom side 410 and a second interior angle 432 with the top side 420. The first interior angle 431 and the second interior angle 432 are each greater than 90 degrees (e.g., 135 degrees). In accordance with an embodiment of the present invention, the angled side 430 angles away from the bottom side 410 at 135 degrees, proceeds straight upward, and then angles back toward the top side 420 at 135 degrees as shown in FIG. 4. Other embodiments are possible as well. For example, the angled side 430 may be rounded or curved in a middle section of the angled side 430. The angled sections 431 and 432 provide less resistance to coating material as it is transferred through this region, facilitating low pressure handling of the materials.

The auger transfer box 400 also includes an input port 440, an output port 450, and a cleanout port 460. The auger transfer box 400 allows for a 90 degree change in direction of coating material within the breading machine. That is, coating material is transported into the input port 440 along an x-axis direction 441, and exits from the output port 450 along a y-axis direction 451. A clean out port 460 may be used to access this area for cleaning as desired. The clean out port 460 is sealed under normal operating conditions, as is the far side 470 of the auger transfer box 400.

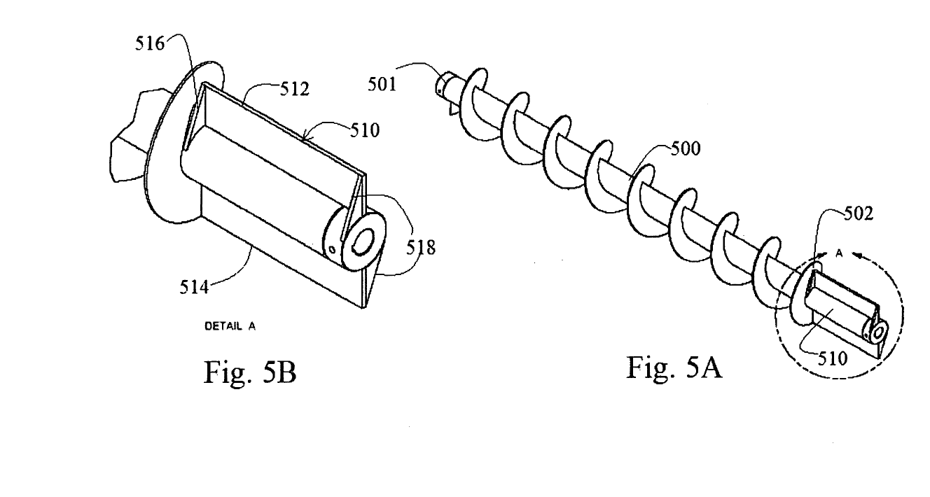

FIG. 5 illustrates several views of an embodiment of a cross-feed screw 500 and paddle 510 used in the breading machines of FIG. 1 and FIG. 2. The cross-feed screw 500 is positioned adjacent the end of the return path of the food product conveyor, so as to accept excess coating material recirculated thereby. The cross-feed screw 500 is an auger type of screw that is able to transport coating material from a first end 501 to a second end 502 as the cross-feed screw 500 rotates. A paddle system 510 is provided on the second end 502 of the cross-feed screw 500. The paddle system 510 may comprise first and second paddle members 512 and 514 on opposing sides of the screw shaft. The members 512 and 514 may be separately attached or an integral assembly as desired. The paddle members 512 and 514 may also have oppositely directed flanges 516 and 518 on the sides thereof, which create a slight box-type of configuration for positively displacing coating materials adjacent thereto as the paddle system 510 rotates as the cross-feed screw 500 rotates. The cross-feed screw 500 corresponds to the screw 245 shown in FIG. 2, which resides in the first horizontal breading transport section 240 of the breading machine 200. The cross-feed screw 500 also resides in the first horizontal breading transport section 150 shown in FIG. 1. The cross-feed screw 500 is driven by a motor attached to the first end 501 to facilitate rotation.

The second end 502 of the cross-feed screw 500 and the attached paddle 510 are positioned within the auger transfer box 400 via the input port 440. The screw 500 and paddle 510 are rotated such that coating material is moved along the screw 500 towards the second end 502 in the x-axis direction 441. When the coating material enters the auger transfer box 400 via the input port 440, the paddle 510 pushes the coating material out of the auger transfer box 400 via the output port 450 in the y-axis direction 451. A first end of a vertical screw (e.g., screw 215 of FIG. 2) is positioned near the output port 450 such that, as the coating material exits the output port 450, the coating material is transported upward, via the vertical screw, towards a second end of the vertical screw. The paddle 510 and the design of the auger transfer box 400 substantially prevent clogging, bridging, and jamming of the coating material, and allow for uniform and complete circulation of coating material within the machine.

Referring to FIG. 1, some of the coating material is intercepted by a spreader screw in the second horizontal breading transport section 160 and is used to deposit a thick layer of coating material onto the main conveyor belt 196 before food products are introduced onto that part of the conveyor belt 196 through an input side 110 of the breading machine 100. Food products are then positioned on the bed of coating material, covering at least the bottoms and some of the sides of food products deposited thereon. Some of the coating material also is directed to the second end of the vertical screw and is deposited into the top hopper 130 of the breading machine 100 via the top hopper feed chute 135, for example. The top coating of food products is supplied via the top hopper, without requiring make up coating material to be introduced therein, thereby maintaining a uniform coating material for depositing onto the tops of food products.

Similarly, referring to FIG. 2, some of the coating material is intercepted by a screw in the second horizontal breading transport section 230 and is used to deposit coating material onto the main conveyor belt 265 before food products are introduced onto that part of the conveyor belt 265 through an input side 270 of the breading machine 200. Some of the coating material makes its way to the second end of the vertical screw 215 and is deposited into the top hopper 250 of the breading machine 200 via the top hopper feed chute, for example.

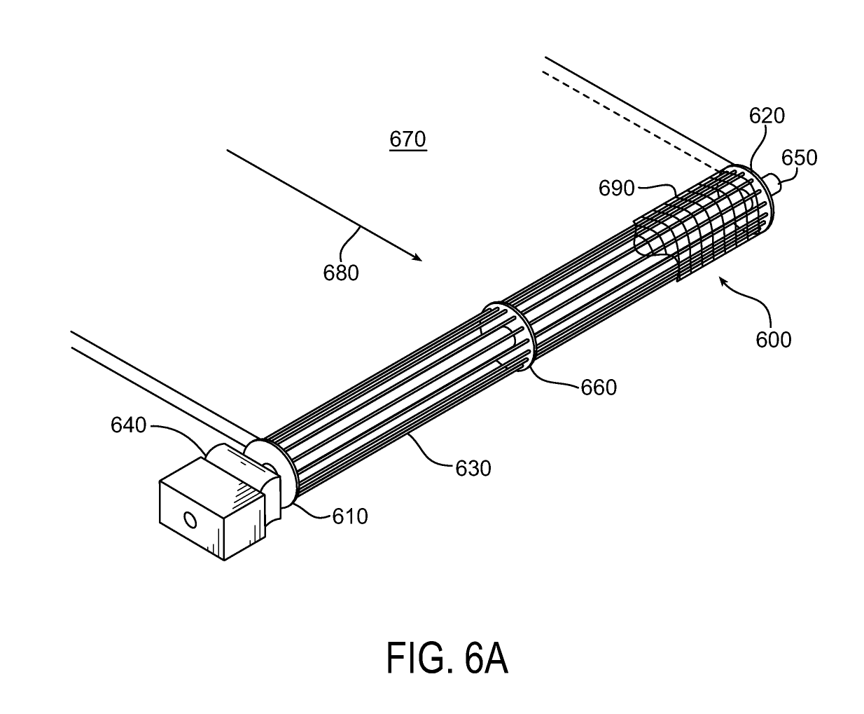

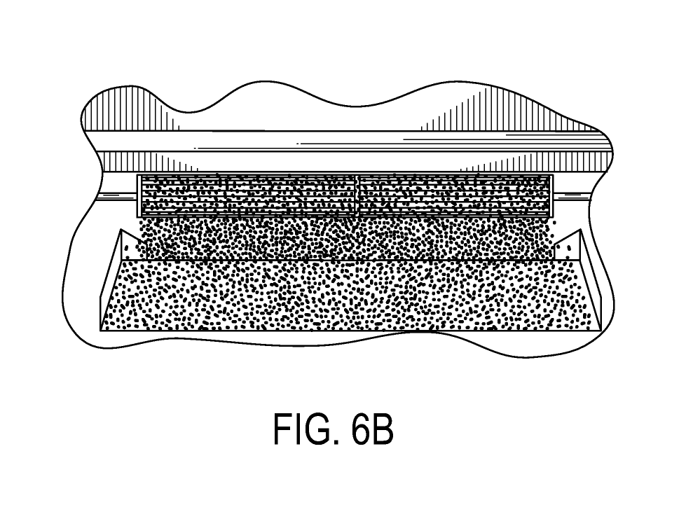

FIG. 6A illustrates an embodiment of a spreader assembly 600 used in the breading machines of FIG. 1 and FIG. 2, for uniformly spreading coating material from the top hopper 130 onto to food products as they pass under the spreader assembly on the main conveyor 196. FIG. 6B illustrates the spreader assembly 600 of FIG. 6A in operation in the coating machine 100 of FIG. 1, which can be seen to provide a uniform distribution of coating material across the width of the conveyor 196 for uniformly coating food products across the belt, without causing undue dust proliferation. Referring to FIG. 1, the spreader assembly 600 (i.e., 190 in FIG. 1) is mounted at an output side of the top hopper 130 and is used to spread coating material over the top and sides of food products traveling along the main conveyor belt 196 within the breading machine 100 as the spreader assembly rotates. Similarly, referring to FIG. 2, the spreader assembly 600 (i.e., 255 in FIG. 2) is mounted at an output side of the top hopper 250 and is used to spread coating material over the top and sides of food products traveling along the main conveyor belt 265 within the breading machine 200.

The spreader assembly 600 includes a first mounting piece 610 and a second mounting member 620 (e.g., circular plates). The spreader assembly 600 also includes a plurality of rods 630 mounted horizontally between the first mounting member 610 and the second mounting member 620. The spreader assembly further includes a motor 640 and a drive shaft 650. The drive shaft 650 connects the motor to at least the first mounting member 610. As shown in FIG. 6, the drive shaft 650 actually travels the length of the spreader assembly 600 connecting the motor to the first mounting member 610, the second mounting member 620, and a third mounting member 660 (which may also be a circular disk). The variable speed motor 640 causes the drive shaft 650 and, therefore, the mounting pieces (610, 620, 630) and the plurality of rods 630 to rotate or spin. The mounting members 610, 620, and 660 may be of other shapes and configuration (e.g., squares, cubes, triangles), in accordance with various alternative embodiments of the spreader assembly 600.

In the embodiment of FIG. 6, the plurality of rods 630 are evenly spaced around the perimeters of the three circular disk mounting members 610, 620, and 660, forming a substantially cylindrical shape. The first ends of the plurality of rods 630 connect to the first mounting member 610 and the second ends of the plurality of rods 630 connect to the second mounting member 620. The rods 630 pass through the third mounting member 660. As an alternative, there may be two sets of mounting rods including a first set that connects between the first mounting member 610 and the third mounting member 660, and a second set that connects between the third mounting member 660 and the second mounting member 620.

A conveyor belt 670 within the top hopper (e.g., 130 or 250) transports the coating material within the top hopper towards the spreader assembly 600, such as in the z-direction 680. As the coating material is uniformly distributed to the spinning spreader assembly 600, the coating material is distributed vertically downward, in a uniform curtain of coating material, onto the food products below the spreader assembly. The action of the spreader assembly 600 results in the coating material being distributed evenly on the top and sides of the food products. For some applications, it may be desirable to form a dust-like cloud of coating material to coat food products as they pass under the spreader assembly 600. For such an application, the user may selectively apply a screen or mesh member 690 to the system 600, such as mounted over the rods 630. The screen member 690 may have a mesh size to create a fine dusting of coating material.

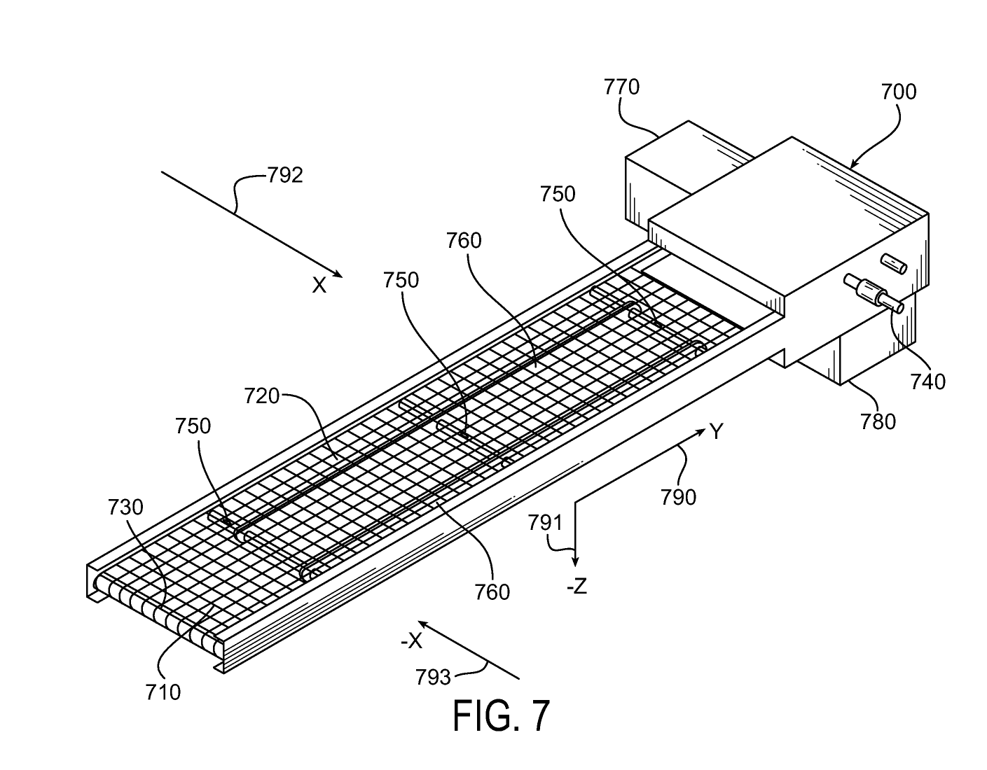

FIG. 7 illustrates an embodiment of a filter assembly 700 that may be used in the breading machines of FIG. 1 and FIG. 2. The filter assembly 700 is desirably positioned adjacent an end of the pan that the main food product conveyor 196 moves within over much of its tip run to maintain a bottom layer of coating material therewith. After the pan terminates, coating material that is not used in coating of food products on the belt can fall through the mesh belt 196, and onto the filter assembly 700. The filter assembly 700 may comprise an operable meshed conveyor belt 710 that is positioned to intercept excess coating materials falling through the main conveyor 196. As coating materials are deposited on the filter assembly 700, to filter out clumps of coating and or other materials, such a batter clumps or food pieces or particles. The filter assembly 700 can be seen in FIG. 1 as filter assembly 180 and in FIG. 2 as filter assembly 260. The filter assembly 700 is oriented substantially perpendicular to and between an upper forward food product path and a lower return path of the main food product conveyor belt (e.g., 196 or 265) of the breading machine. As a result, after food products on the conveyor belt 196 are coated, the main food product conveyor belt 196 pushes excess coating material onto the meshed conveyor belt 710 in a direction x at 792. Smaller, unclumped particles of the coating material fall through the meshed conveyor belt 710 in a direction z at 791 and onto the lower return path of the main food product conveyor belt, moving in a direction −x at 793, for reuse within the breading machine. Larger, clumped coating material is carried out of the breading machine via the meshed conveyor belt 710 in a direction y at 790 and is output via the exit chute 780 of the filter assembly 700. The main food product conveyor belt carries coated food products over the filter assembly 700 in the direction x 792 towards an output end of the breading machine. Removing clumps of coating material helps prevent clogging, bridging, and jamming of coating material within the breading machine as it is circulated through the machine, and allows unclumped coating material to be reused.

The filter assembly 700 may comprise a frame 720 and a tension shaft 730 mounted across the frame 720 at a first end of the filter assembly 700. The filter assembly 700 also includes a drive shaft 740 mounted across the frame 720 at a second end of the filter assembly 700. The filter assembly 700 further includes at least two belt support shafts 750 mounted across the frame 720 between the tension shaft 730 and the drive shaft 740. The filter assembly 700 also includes at least one belt support 760 mounted between at least two belt support shafts 750. A motor 770 is connected to the drive shaft 740 to drive the meshed conveyor belt 710. The meshed conveyor belt 710 travels around the tension shaft 730 and the drive shaft 740 along a length of the filter assembly 700 when driven by the motor 770. The conveyor 710 is also vibrated as it moves, so as to effectively and quickly sift the materials falling thereon, and avoid clogging at this area, such as by at least one vibrator element.

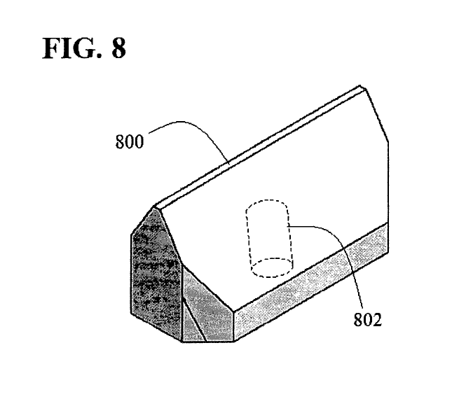

FIG. 8 illustrates several views of an embodiment of an at least one vibrator element 800 that may be used in the vibrating filter assembly 700 of FIG. 7. The vibrator element 800 may be wedge shaped, however, other shapes are possible as well and contemplated in the present invention. Several vibrator elements 800 may be mounted beneath the filter conveyor belt 710 on support shafts 750, via a mounting hole 802. As the filter conveyor belt moves across the vibrator elements 800, the filter belt vibrates, which helps smaller particles of the coating material to fall through the filter belt and onto the lower return path of the main conveyor belt. Other mechanisms for causing vibration of the belt 710 would occur to those skilled in the art, and are contemplated herein.

In accordance with an alternative embodiment of the present invention, a pan may be selectively inserted beneath the filter conveyor belt to prevent the coating material from falling through the filter conveyor belt and onto the lower return path. As a result, the breading machine may be unloaded (i.e., all coating material may be removed from the breading machine, such as for cleaning) using the filter assembly 700 with the inserted pan.

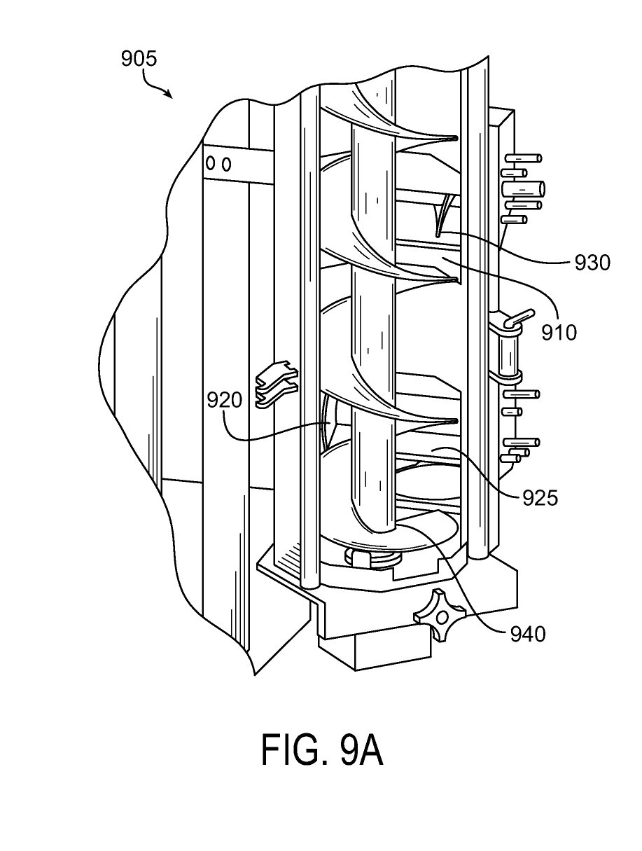

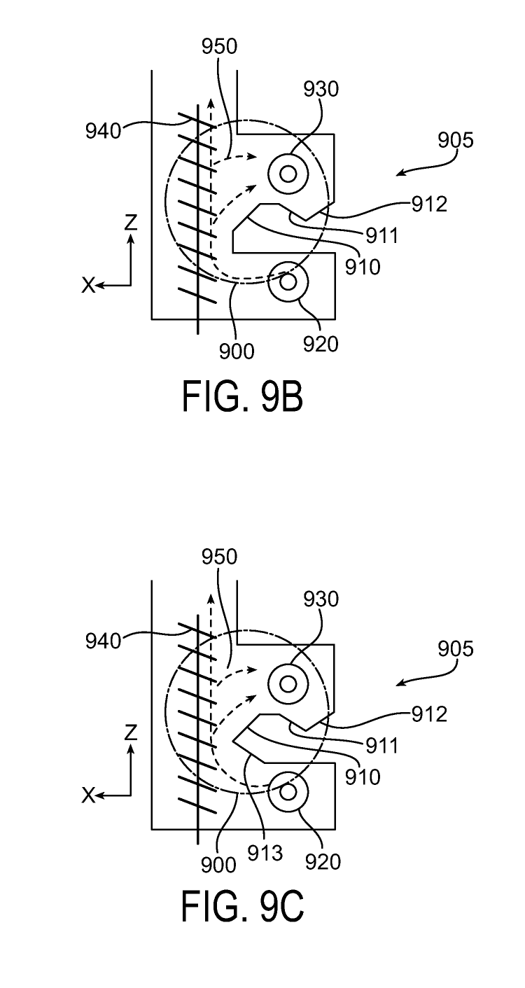

FIGS. 9A-B illustrate several views of a transition region 900 of an embodiment of a low pressure auger assembly 905 in the breading machine according to an embodiment of the present invention. The views show an angled (i.e., not horizontal or vertical) transition surface 910, a cross-feed auger (i.e., screw) 920, a feed auger paddle 925 connected to an end of the cross-feed auger 920, a bottom layer (i.e., spreader) auger (i.e., screw) 930, and a vertical auger (i.e., screw) 940.

Coating material is fed from the cross-feed screw 920 towards the vertical screw 940 by the paddle 925 in an x-direction as previously described. The vertical screw 940 transports the coating material upward in a z-direction. As the coating material travels upward, some of the coating material feeds into the spreader screw 930, by means of the transition region. The spreader screw 930 is used to deposit coating material onto the upper path of the main food product conveyor belt within the breading machine before the food products are introduced onto the main conveyor belt, as previously described.

As the coating material moves up the vertical screw 940, the angled transition surface 910 provides a low-pressure transition pathway for the coating material to transition to the spreader screw 930 (see flow direction of coating material 950). A sharp 90-degree transition (i.e., vertical to horizontal transition) would tend to create a larger back pressure within the transition region 900 which can cause clogging, jamming, or bridging of the coating material, as well as cause undue wear on the screw motors and components. The angled transition surface 910 opens up the pathway, helping to prevent a larger back pressure that could cause such problems. Also, the angled surfaces 911 and 912 also help to maintain a low pressure within the auger assembly 905. Not all of the coating material is transitioned to the spreader screw 930, and a second portion of the coating material continues up the vertical screw 940 in the z-direction towards the top hopper chute, as previously described.

FIG. 9C illustrates an alternative embodiment of a transition region 900 of a low pressure auger assembly 905 in the breading machine of FIG. 1. The only difference from that of FIG. 9B is the additional angled transition surface 913. This additional angled transition surface 913 opens up the transition region 900 even further, ensuring low pressure operation.

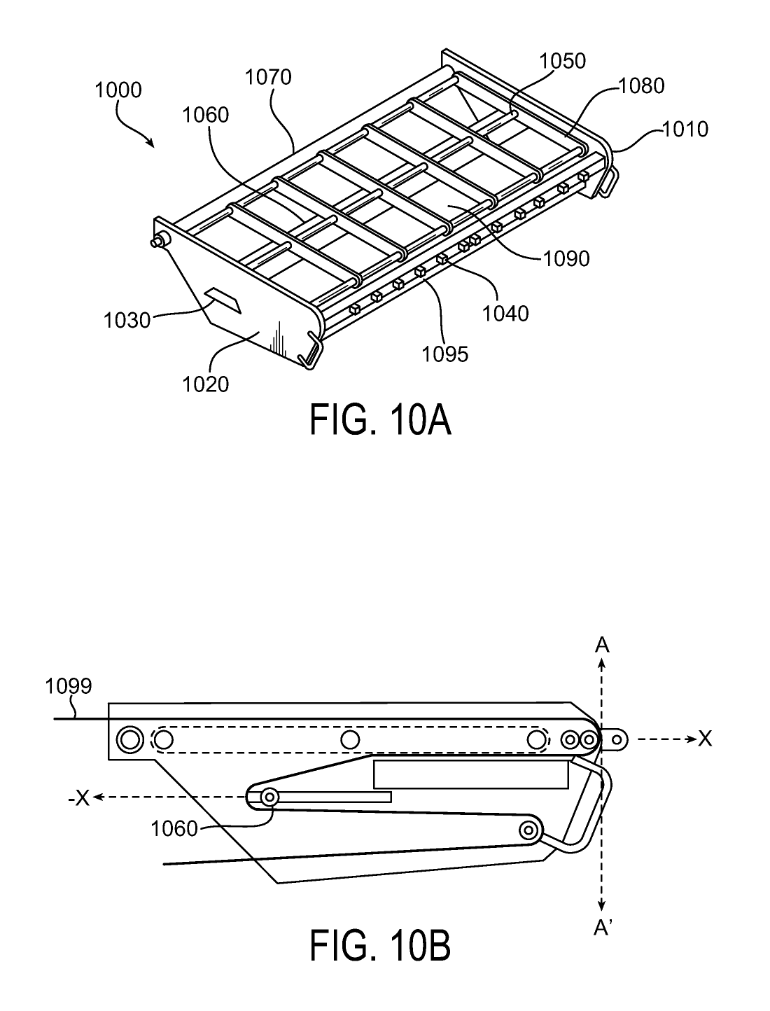

FIGS. 10A-B illustrate views of an embodiment of an in-line belt tensioning assembly 1000 of an embodiment of the breading machine 100 of FIG. 1. The in-line belt tensioning assembly 1000 is the part of the main food product conveyor belt system, and allows selective tensioning of the main conveyor belt 196, without altering the effective length of the belt 196.

The in-line belt tensioning assembly 1000 comprises a left side pan 1010, a right side pan 1020, a tension bracket 1030, an end roller 1040, a support shaft 1050, a tension shaft 1060, a pivot shaft 1070, a belt support 1080, a return pan 1090, and an idler shaft 1095. The main food product conveyor belt 1099 is shown transitioning through the in-line belt tensioning assembly 1000. To adjust the tension on the belt 1099, the tension bracket 1030 is moved in the x-direction or the −x-direction, thereby moving the tension shaft 1060 in the x-direction or the −x-direction to decrease or increase the tension on the belt 1099. As a result, the tension on the belt 1099 may be adjusted without increasing the overall length of the upper forward path of the belt 1099, for example, beyond the imaginary line A-A′ in the x-direction.

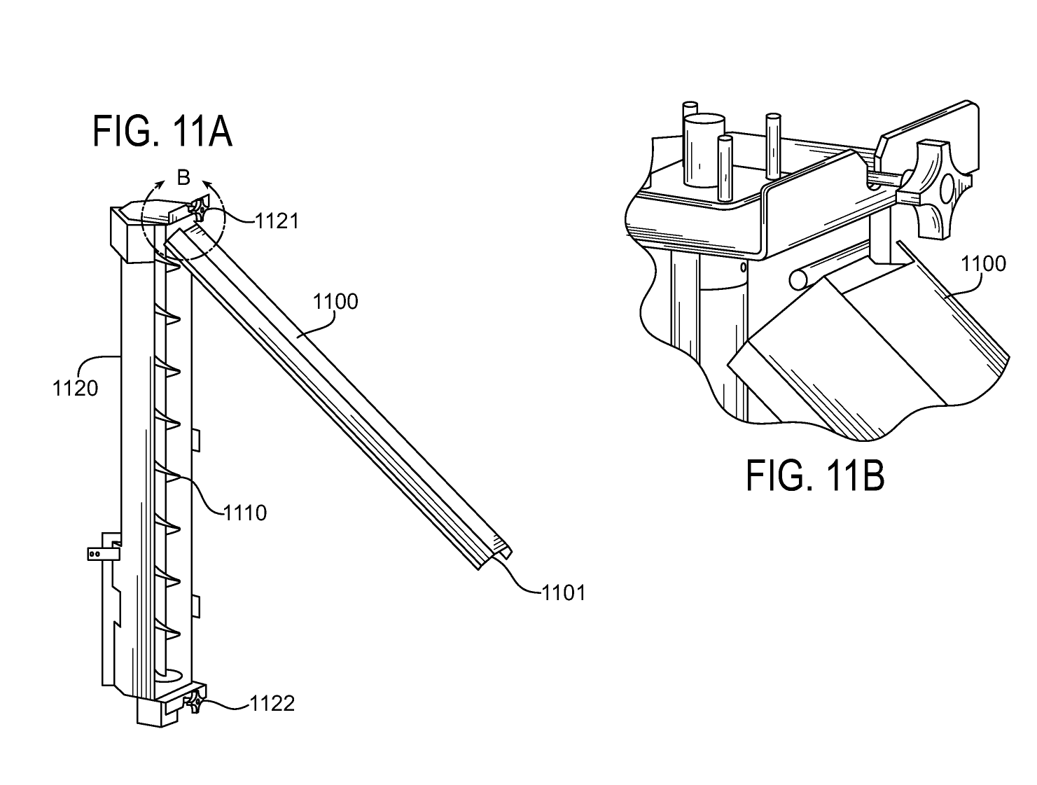

FIGS. 11A-B illustrate an embodiment of a hinged auger guard 1100 which may be used in the breading machine according to the invention. The hinged auger guard 1100, as shown in FIG. 11, is to protect an operator from the vertical screw 1110. However, a hinged auger guard may be used on other screws as well (e.g., a cross-feed screw or a spreader screw). During normal operation, the hinged auger guard 1100 is hinged to the vertical screw assembly 1120 at a first end 1121 and is bolted to the vertical screw assembly 1120 at a second end 1122, preventing anyone from inadvertently touching the rotating vertical screw 1110. In this position, the auger guard prevents access to screw for safety, but is comprised of an open mesh, so as to allow cleaning of the auger even with the guard in the closed position. Thus, water and/or cleaning solutions may be sprayed through the guard while it is in the closed position, simplifying cleaning processes. In FIG. 11, the hinged auger guard is shown in an open position (i.e., the unhinged end 1101 of the hinged auger guard 1100 is unbolted or unfastened from the second end 1122). As a result, when a trained maintenance person needs access to the auger, the guard can be easily opened as shown, to gain access to the vertical screw 1110. Access is provided simply by unbolting or unfastening one end 1101 of the auger guard 1100 and pivoting the auger guard 1100 about the hinged end 1121. This is usually done when performing maintenance on or when more thorough cleaning the screw is required.

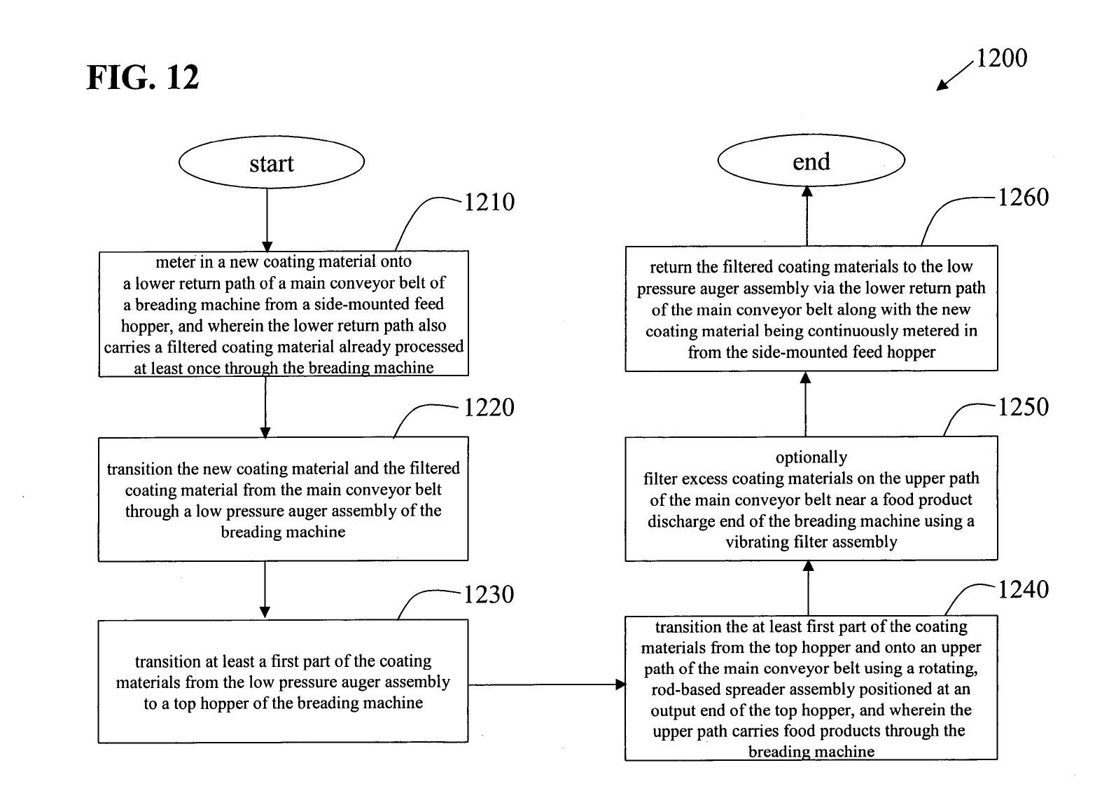

FIG. 12 illustrates an embodiment of a method 1200 to stabilize a coating material within the breading machine according to the present invention. The method 1200 uses at least the side-mounted feed hopper 300 of FIG. 3, and the various parts of the low pressure auger assembly shown in FIG. 4 and FIG. 5 and FIGS. 9A-9C.

In step 1210, new (i.e., fresh) coating material is metered in and onto a lower return path of a main conveyor belt of the breading machine from a side-mounted feed hopper. The lower return path also carries a filtered coating material that has already been processed at least once through the breading machine. In step 1220, the new coating material and the previously filtered coating material is thoroughly mixed and transitioned from the main conveyor belt through a low pressure auger assembly of the breading machine, forming a mixture of the new coating material and the filtered coating material. In step 1230, at least a first part of the coating materials are transitioned from the low pressure auger assembly to a top hopper of the breading machine. In step 1240, the at least first part of the coating materials are transitioned from the top hopper and onto an upper path of the main conveyor belt for coating the tops and sides of food products on the belt, such as by the rotating, rod-based spreader assembly positioned at an output end of the top hopper as described. The upper path carries food products through the breading machine. As a result, the food products are coated with the coating materials in a uniform manner.

In step 1250, excess coating materials (i.e., coating material that has not stuck to the food products) is filtered on the upper path of the main conveyor belt near a food product discharge end of the breading machine using a vibrating filter assembly. As a result, larger clumps of coating material are removed from the breading machine and only smaller particles of coating material remain in the breading machine. In step 1260, the filtered coating materials are returned to the low pressure auger assembly via the lower return path of the main conveyor belt along with the new coating material that is continuously being metered in from the side-mounted feed hopper to replace coating material that has stuck to the food products. The method continues as new food products are introduced into the breading machine for coating.

As a result, the coating material within the breading machine that gets applied to the food products comprises a stabilized mixture of new coating material and previously filtered coating material. Further, all of the excess coating materials (i.e., 100%) are filtered by the vibrating filter assembly. The vibrating filter assembly may also remove parts of food products (e.g., smaller chicken parts) that have broken off of the main food products and have fallen through the main conveyor belt and onto the vibrating filter assembly.

In summary, an improved breading machine is disclosed for coating food products with a coating material (e.g., flour, bread crumbs, cracker meal). The improved breading machine includes an improved auger assembly, an improved spreader assembly, a side-mounted feed hopper, and a filter assembly. All of the improvements help to prevent clogging, bridging, and jamming of the coating material within the breading machine.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method to stabilize a coating material within a breading machine, said method comprising:
continuously metering in a new coating material onto a lower return path of a main conveyor belt of said breading machine from a side-mounted feed hopper, and wherein said lower return path also carries a filtered coating material already processed at least once through said breading machine;
transitioning said new coating material and said filtered coating material from said main conveyor belt through a low pressure auger assembly of said breading machine;
transitioning at least a first part of said coating materials from said low pressure auger assembly to a top hopper of said breading machine;
transitioning said at least first part of said coating materials from said top hopper and onto an upper path of said main conveyor belt using a rotating rod-based spreader assembly positioned at an output end of said top hopper, and wherein said upper path carries food products through said breading machine;
filtering excess coating materials on said upper path of said main conveyor belt near a food product discharge end of said breading machine using a vibrating filter assembly; and
returning said filtered coating materials to said low pressure auger assembly via said lower return path of said main conveyor belt along with said new coating material being continuously metered in from said side-mounted feed hopper.

2. The method of claim 1 wherein 100% of said excess coating materials are filtered by said filter assembly.

3. The method of claim 1 wherein said excess coating materials include a part of said coating materials that did not adhere to said food products on a previous pass through said breading machine.

4. The method of claim 1 wherein the rod-based spreader assembly comprises:
at least two mounting pieces;
a plurality of rods mounted horizontally between said at least two mounting pieces;
a motor; and
a drive shaft connecting said motor and at least one of said two mounting pieces.

5. The method of claim 1 wherein the rod-based spreader assembly comprises:
a first mounting piece, a second mounting piece, and a third mounting piece, the mounting pieces being coaxial;
a first plurality of rods mounted horizontally between said first and second mounting pieces;
a second plurality of rods mounted horizontally between said second and third mounting pieces;
a motor; and
a drive shaft connecting said motor and at least one of said mounting pieces.

6. The method of claim 1 wherein the vibrating filter assembly comprises an operable filter conveyor belt positioned at least adjacent a food product discharge end of said breading machine and oriented substantially perpendicular to and between an upper forward food product path and a lower return path of a main food product conveyor belt of said breading machine such that said main food product conveyor belt pushes said coating material onto said filter conveyor belt, and wherein smaller particles of said coating material fall through said filter conveyor belt and onto said lower return path of said main food product conveyor belt for reuse within said breading machine as said filter conveyor belt vibrates, and wherein larger clumps of said coating material are carried out of said breading machine by said filter conveyor belt.

7. The method of claim 1 wherein the vibrating filer assembly comprises an operable filter conveyor belt positioned near a food product discharge end of said breading machine and oriented substantially perpendicular to and between an upper forward food product path and a lower return path of a main food product conveyor belt of said breading machine and a selectively insertable pan positioned beneath the filter conveyor belt and above the lower return path, such that said main food product conveyor belt pushes said coating material onto said filter conveyor belt, and wherein smaller particles of said coating material fall through said filter conveyor belt and onto said pan for removal from said breading machine, and wherein larger clumps of said coating material are carried out of said breading machine by said filter conveyor belt.
